(19) United States
(12) Patent Application Publication
(10) Pub. No.: US 2015/0335135 A1
(43) Pub. Date: Nov. 26, 2015

(54) Illuminated Shoulder Strap

(71) Applicant: Matthew Stoll, San Mateo, CA (US)

(72) Inventor: Matthew Stoll, San Mateo, CA (US)

(21) Appl. No.: 14/282,454

(22) Filed: May 20, 2014

(51) Int. Cl. A45F 3/04; A45C 15/06; F21V 23/04; F21L 4/08; F21S 4/00; F21V 33/00

(52) U.S. Cl. CPC A45F 3/042; F21S 4/008; F21V 33/0076; F21V 23/0435; F21L 4/08; A45C 15/06; F21Y 2103/003

(57) ABSTRACT

An illuminated strap apparatus for the strap of a backpack, shoulder-bag, satchel, or other similar shoulder-mounted bag is described. The illuminated strap apparatus employs at least one LED strip which is preferably powered by a rechargeable battery. The illuminated strap apparatus is configured to be integrated into conventional backpacks and bags, as well as into proprietary backpacks which are pre-equipped with a clear plastic sleeve lining the entirety of the straps of the backpack or other similar shoulder bag. The illuminated strap apparatus includes wireless remote control configured to interface with a controller of the illuminated strap apparatus, and provide illumination options to the user such as flashing frequency, brightness, fade, and color.

### FIELD OF THE PRESENT INVENTION

The present invention relates to handles or straps, and more specifically relating to straps configured for placement over the shoulder in order to facilitate transport of luggage in an easy and comfortable fashion.

### BACKGROUND OF THE PRESENT INVENTION

It is known that in low light conditions, an individual is at a higher risk of being struck by a vehicle or other individual due to a lack of visibility. Often times, individuals will carry a flash light with them, or wear bright clothing, but this is not always practical, and a flashlight can easily be forgotten at home. Children, in part due to their smaller size, can be even more difficult to see in the dark. Thus there is a need to increase the nighttime visibility of people in order to prevent injury.

It is known that many individuals, especially children, prefer to use backpacks or similar shoulder bags to facilitate the transport of items while keeping the hands free for other tasks. If there were an easy way to illuminate a portion of the shoulder bag that the individual is carrying, his or her visibility and safety would be greatly increased at night, and his or her arms would be freed of having to carry a flashlight, reflector, or other illuminating safety device.

Thus, there is a need for an illuminated apparatus for the strap of a backpack that would provide an easy means of illuminating the front and rear of an individual wearing the backpack with a series of lights securely placed on the straps of the backpack.

In the past, others have attempted to illuminate individuals at night with a variety of methods. Other backpacks and bags have been equipped with reflectors and lights for this purpose, however the usually employ unidirectional lights that are only capable of projecting light in a fairly narrow range. Additionally, these lights are conventionally only one color, and may blink or flash at a consistent frequency that may not be altered by the user. Likewise, it is rare that the lights currently employed by other versions of illuminated backpacks or packs have multiple colors of light, in order to contrast against the shirt color of the user.

Other prior art attempts to solve this issue with clusters of LED lights that are conventionally single-colored, which do not serve to illuminate the individual well, as they are confined to a small space, and do not run the length of the full backpack or bag strap. Single colored lights may not be changed in order to best contrast with the clothing of the user. Additionally, the lights should be preferably spaced out over a larger surface area in order to provide for the best illumination of the user.

### SUMMARY OF THE PRESENT INVENTION

The present invention is an integrated illuminated strap apparatus, configured with an internal power source, at least one LED light strip, and a wireless controller. The preferred embodiment of the present invention is envisioned to illuminate at least one side of at least one strap of a backpack, satchel, or similar bag or sack configured to be worn on the shoulder of a user. Ideally, the straps of the backpack are equipped with translucent sleeves configured to hold LED light strips.

The LED light strips of the present invention are preferably powered by at least one rechargeable battery. The LED light strips are preferably placed along the center of each strap of the backpack or other shoulder-strapped bag in order to partially illuminate both the front and rear of the individual when the present invention is worn. The translucent sleeves of the preferred embodiment of the present invention are preferably sewn directly onto the shoulder straps of the backpack or similarly shouldered bag. In some embodiments of the present invention, the LED lights strips may be removed from the translucent sleeves affixed to the shoulder straps of the backpack or bag.

### BRIEF DESCRIPTION OF THE DRAWINGS

FIG. 1 depicts the present invention as viewed from the front, equipped to the shoulder straps of a backpack, displaying the back of the backpack.

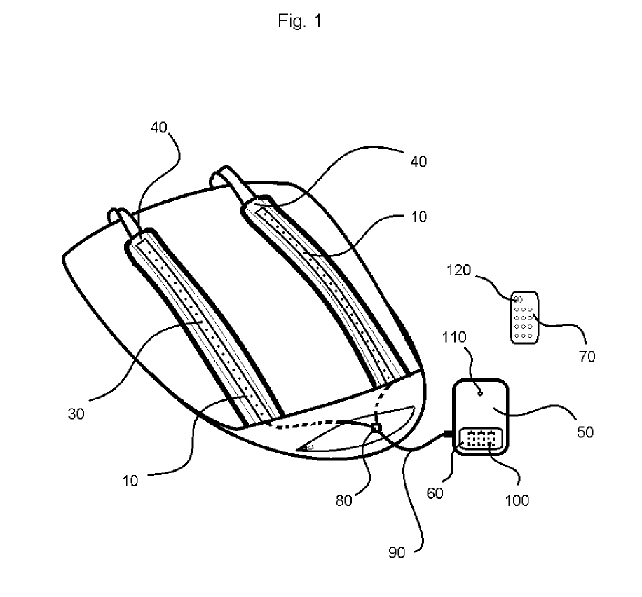

### DETAILED DESCRIPTION OF THE PREFERRED EMBODIMENT

The present invention is an illuminated shoulder strap apparatus designed to illuminate the shoulder straps of a backpack or similarly shouldered bag. The present invention is preferably equipped with at least one LED light strip (10), a power source such as a battery (100), at least one LED bulb (30), and a strap sleeve (40). The present invention is also preferably equipped with a LED light controller (50), providing for the control of the color, fade, flashing frequency, and other options by the user.

The LED Light controller (50) of the present invention is preferably housed within the backpack itself, and may be sewn into a pocket or compartment within the backpack. The LED Light controller (50) contains the battery compartment (60), which houses the battery (100). The battery compartment (60) is preferably configured to accept either conventional rechargeable batteries, or a rechargeable battery pack. The preferred embodiment of the present invention employs a rechargeable battery pack battery cell as a battery (100), which is configured to be charged while housed within the battery compartment (60) of the LED Light controller (50) with a conventional A/C adapter. The LED Light controller (50) is preferably designed to interface wirelessly with a remote controller (70).

The remote controller (70) of the present invention permits the user to easily configure the colors, flashing frequency, intensity, and fade of the LED light strip (10), as well as permit the user to easily activate and deactivate the present invention. The remote controller (70) preferably employs a standard of wireless technology, such as RF or Bluetooth. Bluetooth is ideally preferred as a wireless technology to interface the LED Light controller (50) with the remote controller (70), as it provides for the option of the user to control the present invention with his or her smartphone in addition to, or in lieu of the included remote controller (70). The LED light controller (50) may also be equipped with an indicator light (110) which indicates when power is being supplied to the LED light strip (10), and thus, if the present invention is on or activated. The indicator light (110) may be configured to alert the user when the battery (100) of the present invention needs to be recharged. The indicator light (110) may flash an alternate color when the battery (100) is low. Additionally, the indicator light (110) is useful in troubleshooting the present invention in the event that the LED light strip (10) does not activate when power is supplied.

It is envisioned that a walking user equipped with the present invention is able to activate the LED light strip (10) if a car or similar hazard is coming within proximity of the user with the remote controller (70) instantly. Due to the placement of the LED Light strip (10) on the shoulder straps of the backpack, the LED Lights on the LED Light strip (10) are able to illuminate both the front and the rear of the individual equipped with the present invention. The individual, especially if she or he is a child, is motivated to wear the present invention as it is aesthetically pleasing, as well as safe. Additionally, the user may employ the remote control to opt to flash the LED lights of the LED Light strip (10) at will, which can be useful in the event that the user feels an approaching car has yet to see the individual. In this event, the user may opt to begin flashing the lights in an attempt to ensure the oncoming motorist sees the user, and takes action to prevent hitting and injuring the user.

The wiring of the present invention may vary with various embodiments of the present invention, however it is envisioned that the wiring of the present invention is fairly conventional. The present invention is preferably equipped with a T-Splitter (80) in order to split the supply of power to both LED light strips (10) of the present invention. The T-Splitter (80), accompanied with a conventional wire (90) distribute electricity from the rechargeable battery to the LED Light controller (50) and ultimately the LED light strips (10). The wire (90) is preferably insulated in order to provide durability to the present invention, and to help prevent premature wear.

Additional alternate embodiments of the present invention may include variations on the triggering of the LED Light strips (10). For example, the LED light controller (50) could be equipped with an optional proximity sensor that is preferably configured to illuminate the LED light strips (10) of the present invention when a vehicle or similar hazard is detected. Similarly, and ambient light sensor may trigger the activation of the LED Light strips (10) when the ambient lighting is reduced to a pre-defined level. Likewise, a movement sensor could be integrated into the LED light controller (50) to detect when the backpack is picked up, and turn the LED light strips (10) on, and then later deactivate the LED light strips (10) when the movement sensor fails to detect any movement for a specified period of time.

Additional alternate embodiments of the present invention could include a small speaker which may be configured to sound a small alarm when activated via the remote controller (70) to assist the user in finding the backpack if it is lost at home or other location, helping to differentiate the user's backpack from other backpacks in a group. Further embodiments of the present invention could employ sound or vibration sensors in order to cause the LED light strips (10) to activate and flash in tandem with accompanying music or other sound.

It is envisioned that, although the battery (100) of the present invention is preferably rechargeable, the mechanism by which the battery (100) of the present invention may vary. For example, in some embodiments of the present invention, the battery (100) of the present invention is preferably removable from the battery compartment (60), and is designed to be charged externally of the present invention with a separate battery charger. In other preferred embodiments of the present invention, the battery (100) of the present invention is charged on-board the present invention, with the battery (100) safely maintained within the battery compartment (60). The battery is then charged via a small charging port (110), preferably located simply on the outer casing of the LED light controller (50), the battery compartment (60), or displayed externally, on the strapped bag itself, to facilitate charging without removal of the LED light controller (50) from within the strapped bag.

Having illustrated the present invention, it should be understood that various adjustments and versions might be implemented without venturing away from the essence of the present invention. Further, it should be understood that the present invention is not solely limited to the invention as described in the embodiments above, but further comprises any and all embodiments within the scope of this application.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The exemplary embodiment was chosen and described in order to best explain the principles of the present invention and its practical application, to thereby enable others skilled in the art to best utilize the present invention and various embodiments with various modifications as are suited to the particular use contemplated.

I claim:

1. An illuminating apparatus for the strap of a shoulder bag, comprising:
LED light strips;
wherein said LED light strips include multiple LED bulbs wired together;
a plastic sleeve,
wherein said plastic sleeve is affixed to the strap of the shoulder bag;
an opening, said opening disposed at a first end of said plastic sleeve;
a rechargeable battery;
a LED light controller;
a remote controller; and
wherein said remote controller is configured to control the activation of said LED light strips.

2. The illuminating apparatus for the strap of a shoulder bag of claim 1, further comprising:
wherein said plastic sleeve is clear.

3. The illuminating apparatus for the strap of a shoulder bag of claim 1, wherein said plastic sleeve is sized to a width larger than the width of said LED light strips;

4. The illuminating apparatus for the strap of a shoulder bag of claim 1, wherein said remote controller is wireless.

5. The illuminating apparatus for the strap of a shoulder bag of claim 1, wherein said remote controller is configured to interface with said LED light controller via a private frequency.

6. The illuminating apparatus for the strap of a shoulder bag of claim 1, wherein said remote is a wireless device selected from the following group: a smartphone, a tablet, a laptop, a PDA, and a cell phone.

7. The illuminating apparatus for the strap of a shoulder bag of claim 6, wherein said wireless device communicated with said LED light controller via Bluetooth.

8. An illuminating apparatus for the strap of a shoulder bag comprising:
LED light strips;
wherein said LED light strips include multiple LED bulbs wired together;
a plastic sleeve, wherein said plastic sleeve is translucent;
wherein said plastic sleeve is affixed to the strap of the shoulder bag;
an opening, said opening disposed at a first end of said plastic sleeve;
wherein said plastic sleeve is sized to a width larger than the width of said LED light strips;
a rechargeable battery;
a LED light controller;
a wireless remote controller; and
wherein said wireless remote controller is configured to interface with said LED light controller via a private frequency.
